(19) United States
(12) Patent Application Publication
(10) Pub. No.: US 2008/0185325 A1
(43) Pub. Date: Aug. 7, 2008

(54) Pollutant Trap

(75) Inventors: Christopher Adam Murray, Oakville (CA); Scott Gordon Monteith, Toronto (CA)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Imbrium Systems Inc.

(21) Appl. No.: 12/024,780

(22) Filed: Feb. 1, 2008

Related U.S. Application Data
(60) Provisional application No. 60/887,745, filed on Feb. 1, 2007.
(60) Provisional application No. 61/021,425, filed on Jan. 16, 2008.

(51) Int. Cl. B01D 21/34; B01D 21/28

(52) U.S. Cl. 210/123; 210/521

(57) ABSTRACT

A system for removing pollutants from a liquid. The system has a tank with a bypass chamber, a treatment chamber, inlet and outlet ports. A dividing wall is located within the tank and defines the bypass chamber and the treatment chamber. The dividing wall has an inlet opening, one or more outlet openings, retaining rods forming a retention space at least partially below the inlet opening, and a vertically-extending weir between the inlet opening and the outlet opening(s). The inlet opening receives polluted liquid from the inlet port and the one or more outlet openings output a cleaned liquid to the outlet port. A float in the treatment chamber is adapted to float in a retention space formed by the retaining rods. The float is adapted to rise against the inlet opening when a fluid level in the treatment chamber reaches a predetermined level to substantially block the inlet opening.

### CROSS REFERENCE TO RELATED APPLICATIONS

The present invention claims priority to U.S. Provisional Application Ser. No. 60/887,745, filed on Feb. 1, 2007, and U.S. Provisional Application Ser. No. 61/021,425, filed on Jan. 16, 2008, the contents of both of which are incorporated herein by reference in their entirety.

### FIELD OF THE INVENTION

The present invention relates to water treatment systems, in general, and gross pollutant traps for a water treatment system, in particular.

### BACKGROUND OF THE INVENTION

Liquids such as stormwater runoff and snow melt travel over the ground or impervious surfaces—e.g., roofs of buildings, homes and sheds, roadways, parking lots, sidewalks and driveways—and drain into natural or manmade drainage ways. In some cases, such runoff drains directly into bodies of water. Stormwater runoff often does not receive any treatment before it enters streams, lakes, and other surface waters, and it is a major source of water pollution. For example, various harmful pollutants, such as sediment, oils (automotive and other kinds), oil-based particles, pesticides, fertilizer, litter, bacteria, and trace metals may be washed off of ground and structural surfaces by stormwater, and may drain into nearby streams, lakes and other surface waters.

In efforts to capture such pollutants, various stormwater interceptors have been provided in the prior art. Examples of such devices are illustrated, for example, in U.S. Pat. Nos. 4,985,148; 5,498,331; 6,371,690; 5,753,115; 6,068,765; 5,725,760; 5,746,912; and 5,849,181. All of the foregoing references are incorporate herein. Nevertheless, there still remains a desire for systems and apparatus adapted to treat polluted stormwater runoff, snowmelt, and liquids in general, to help remove unwanted pollutants and other materials or objects.

### SUMMARY OF THE INVENTION

In one aspect, there is provided a system for removing pollutants from a polluted liquid. The system includes a tank having a bypass chamber, a treatment chamber, an inlet port and an outlet port. A dividing wall is located within the tank and defines the bypass chamber and the treatment chamber. The dividing wall has an inlet opening, one or more outlet openings, a plurality of retaining rods forming a retention space located at least partially below the inlet opening, and a vertically-extending weir located between the inlet opening and the one or more outlet openings. The inlet opening is positioned to receive the polluted liquid from the inlet port and the one or more outlet openings are positioned to output a cleaned liquid to the outlet port. A float may be located in the treatment chamber and adapted to float in a retention space formed by the plurality of retaining rods. The float is adapted to rise against the inlet opening when a fluid level in the treatment chamber reaches a predetermined level to substantially block the inlet opening.

In another aspect, there is provided an insert for removing pollutants from a polluted liquid. The insert includes a housing having a first aperture adapted to receive the polluted liquid, a second aperture adapted to output cleaned liquid, a weir positioned between the first aperture and the second aperture, and plurality of retaining rods extending below a bottom surface of the insert.

In another aspect, there is provided an insert for removing pollutants from a polluted liquid. The insert includes an inlet opening and a plurality of outlet openings formed through the insert. The inlet opening is positioned at a first elevation and each of the plurality of outlet openings is positioned at a second elevation, the first elevation being greater than the second elevation. The insert also has a weir having an elevated weir portion that is located between the inlet opening and the plurality of the outlet openings and is non-symmetrical relative to an edge of the inlet opening. One or more retention devices extend from the bottom surface of the insert and form a dimensional space adapted to receive a mechanism dimensioned to reside in the dimensional space and substantially block the inlet opening upon detecting a predetermined level of fluid below the insert.

### BRIEF DESCRIPTION OF THE DRAWINGS

These and other features and aspects of the embodiments of the present invention will become better understood when the following detailed description is read with reference to the accompanying drawings, in which like reference numerals represent like components throughout the drawings.

FIG. 1 is a cross-sectional side view of a gross pollutant trap having an insert and float in accordance with an embodiment of the present invention.

FIG. 2 is a perspective view of a gross pollutant trap having an insert in accordance with an embodiment of the present invention.

FIG. 3 is a perspective view of an insert and float in accordance with an embodiments of the present invention.

FIG. 4 is an alternate view of the embodiment of FIG. 3.

FIG. 5 is a plan view of an insert in accordance with an embodiment of the present invention.

FIG. 6 is a perspective view of a gross pollutant trap having an insert in accordance with another embodiment of the present invention.

FIG. 7 is a perspective view of an insert and float in accordance with an embodiments of the present invention.

FIG. 8 is an alternate view of the embodiment of FIG. 7.

FIG. 9 is a plan view of the insert of FIG. 7.

FIG. 10 is a cutaway view the insert of FIG. 7, shown along line 10-10 of FIG. 9.

FIG. 11 is a cutaway view the insert of FIG. 7, shown along line 11-11 of FIG. 9.

### DETAILED DESCRIPTION

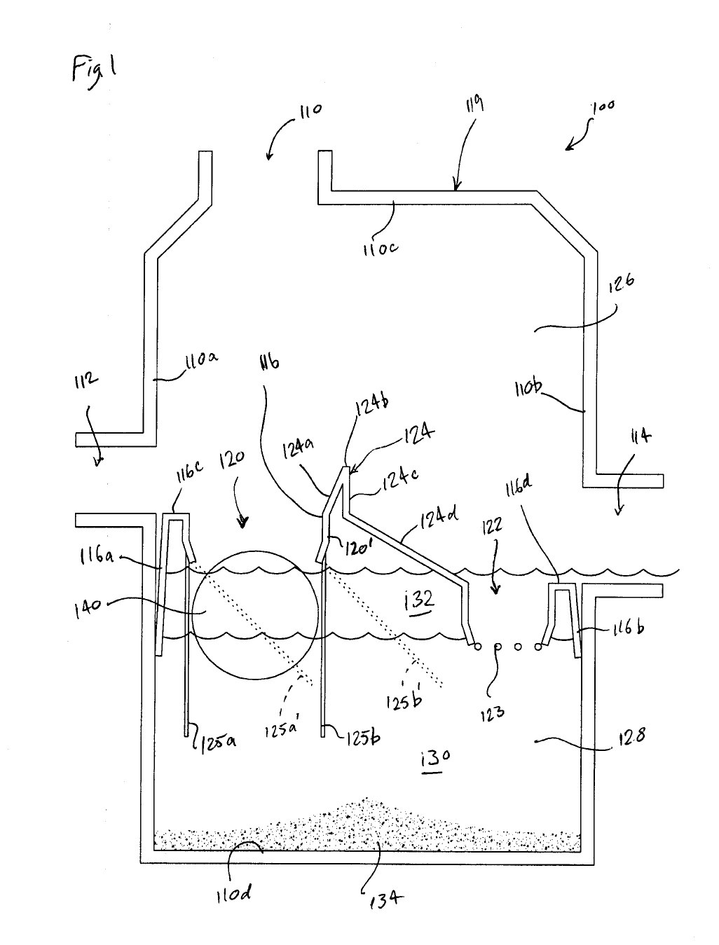

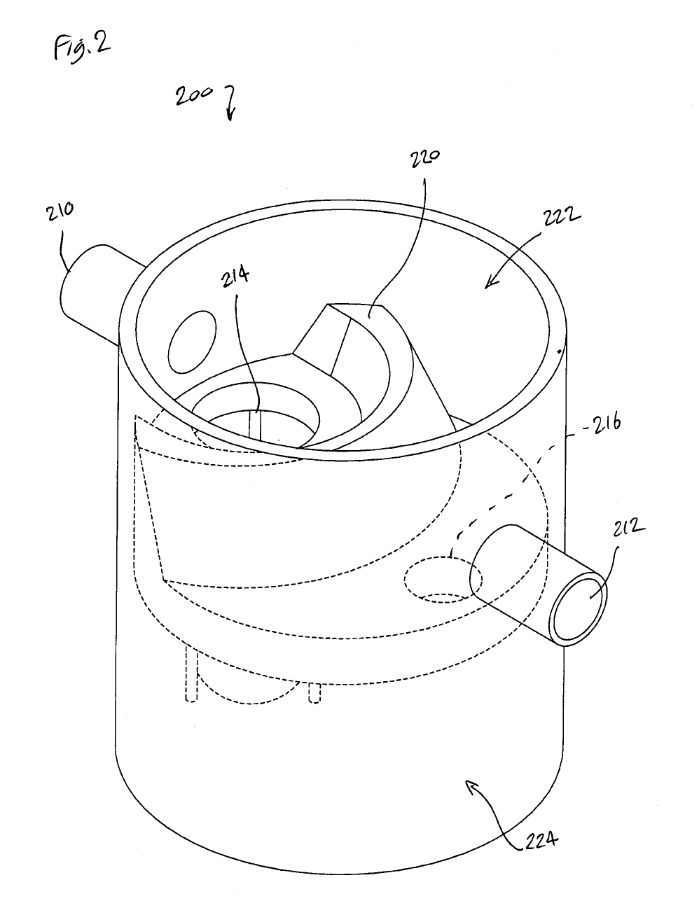

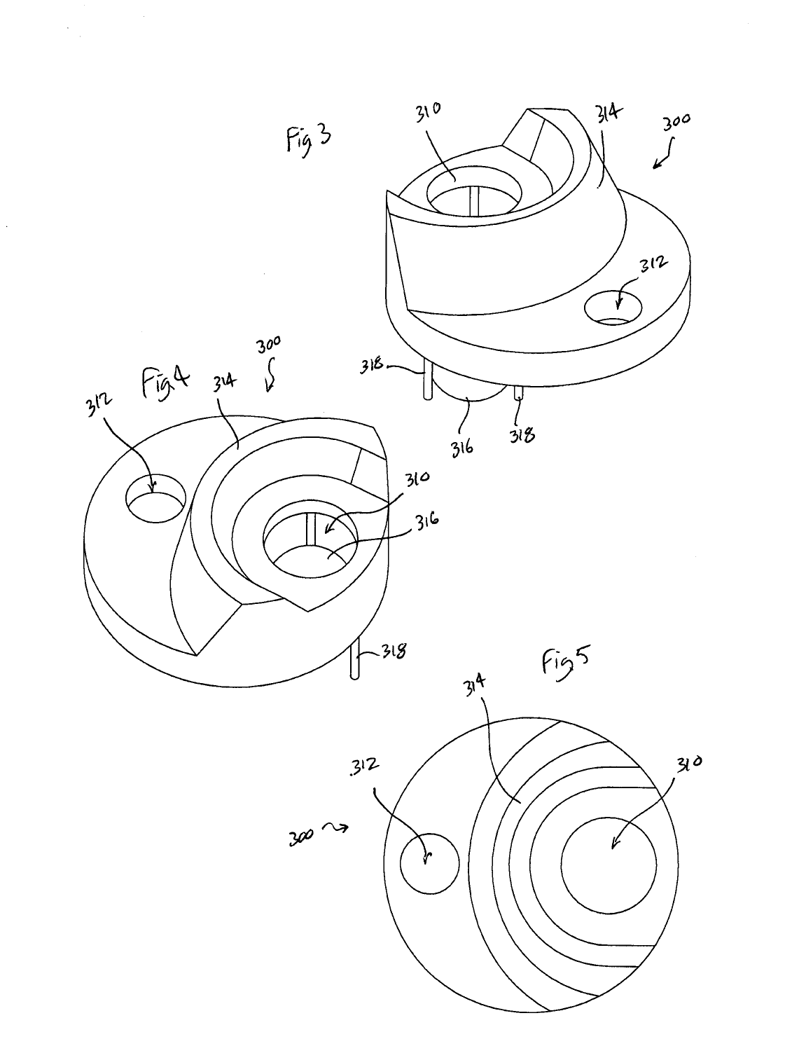

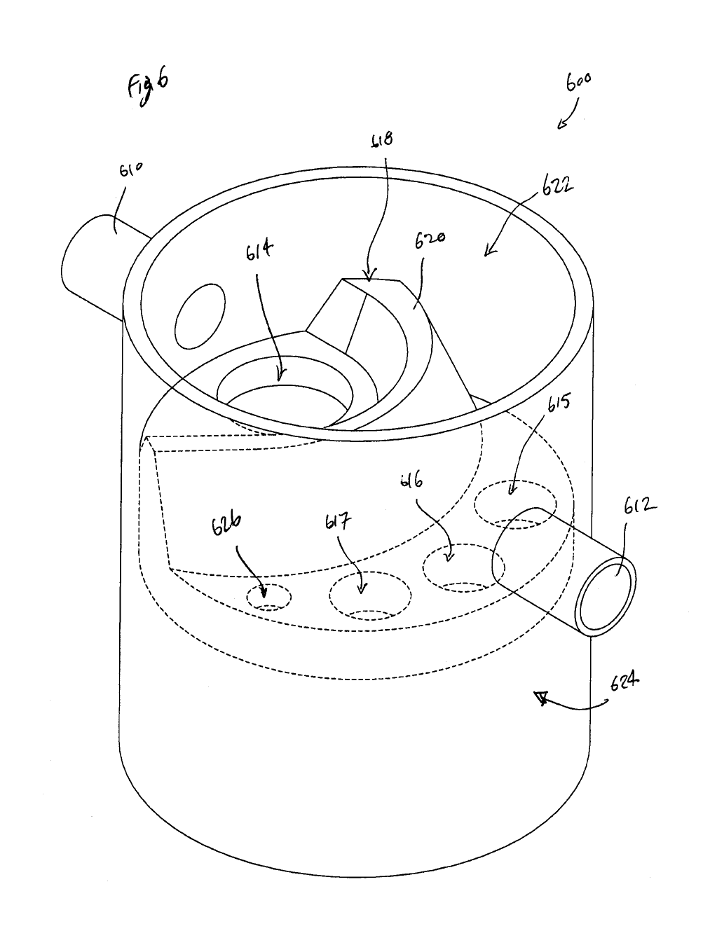

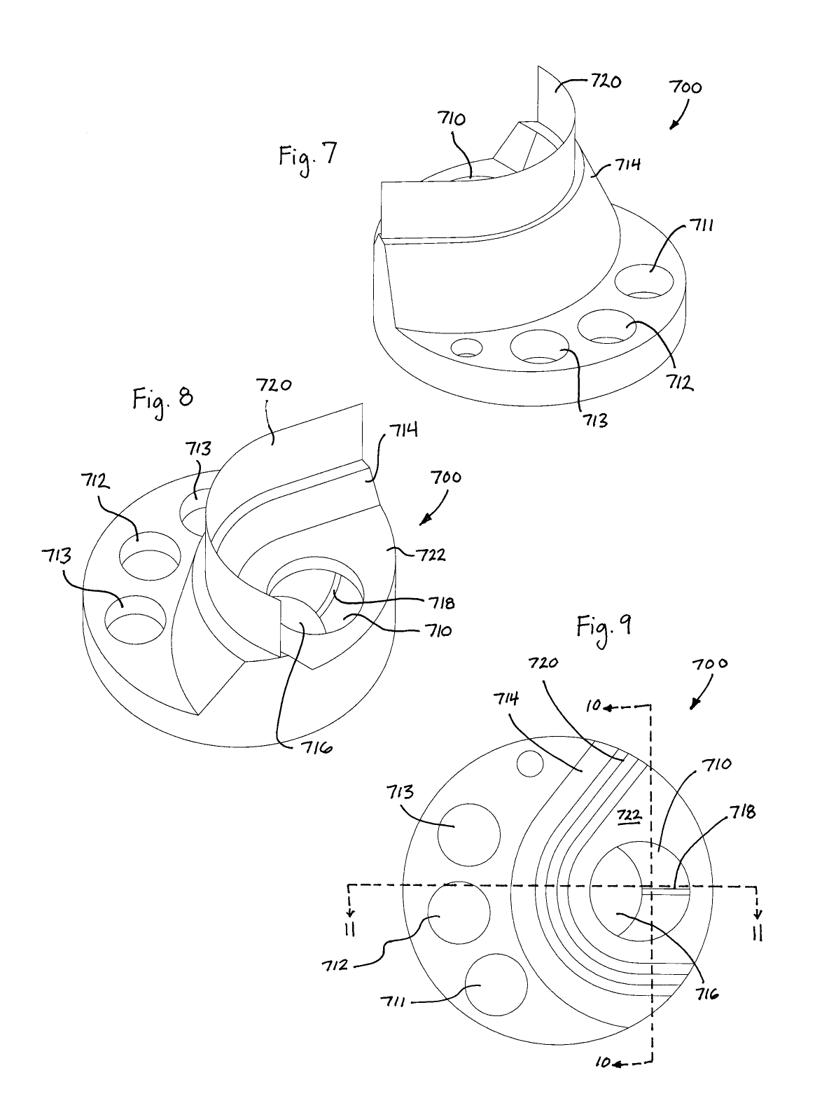

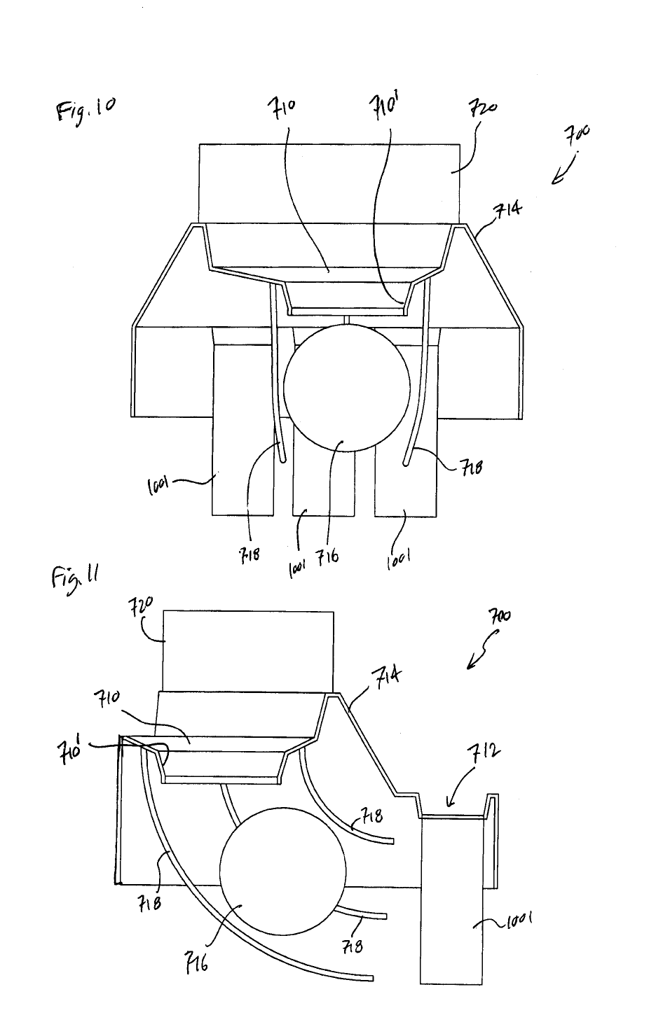

FIG. 1 is a cross-sectional side view of a gross pollutant trap having an insert and float in accordance with an exemplary embodiment of the present invention. The gross pollutant trap 100 includes a tank 119 having a dividing wall, such as an insert 116, and a float 140. The insert 116 is disposed within the tank 119 and the float 140 is located under the insert 116 and within the tank 119.

In some embodiments, the tank 119 may be a chamber having as its boundaries a first interior side wall 110a, a second interior side wall 110b opposite the first interior side wall 110a, a top interior wall 110c and a bottom interior wall 110d opposite the top interior wall 110c. In various embodiments, the first interior side wall 110a, second interior side wall 110b, top interior wall 110c and bottom interior wall 110d may be formed of concrete. For example, they may be formed as pre-cast concrete. In various other embodiments, any suitable material may be used as is well-known to those skilled in the art. For example, the tank 119 may comprise fiberglass, aluminum or other metals, and so on. The tank 119 may be formed of a generally water-tight material or have water-sealing coatings, but it may have porous features to allow fluid to pass through the walls. It also may be formed by any combination of parts, such as by forming the side walls 110a, 110b as a concrete cylinder, forming the top and bottom walls 110c, 110d as separate parts, and joining the parts together.

The tank 119 may includes an entry hole 110, an inlet port 112, and an outlet port 114. The entry hole 110 passes through the top interior wall 110c of the tank 119 to provide access for workers and cleaning equipment, provide an inlet for water to enter the tank 119, or both. The inlet port 112 and outlet port 114 may pass through the first side interior wall 110a and the second side interior wall 110b, respectively, to provide conduits through which water or other fluids pass into and out of the tank 119. The inlet port 112 may be higher than the outlet port 114 in order to maintain a hydraulic head within the device and to ensure that fluid does not flow backwards. The entry hole 110, inlet port 112 and outlet port 114 may be formed integrally with the tank, or provided as separate attached parts, such as bolted-on tubes or bonded concrete pipes. Other suitable constructions will be appreciated by persons of ordinary skill in the art.

The tank 119 may include a treatment chamber 128 and a bypass chamber 126. The bypass chamber 126 may be formed in an uppermost portion of tank 119, and the treatment chamber 128 may be formed in a portion of the tank 119 located generally below the bypass chamber 126. The bypass chamber may be disposed to receive liquid communicated into the tank 119 through the inlet port 112 or the entry hole 110, and convey it to the outlet port 114. Depending on the flow conditions, some or all of this liquid may pass through the treatment chamber 128.

The gross pollutant trap 100 has a dividing wall that partitions the tank to form the treatment chamber 128 and the bypass chamber 126. The dividing wall may comprise a single wall or an arrangement of walls, and may be formed as part of the rest of the tank 119 or as a separate insert 116 that is installed into the tank 119. While the embodiments described herein generally refer to an insert 116, this does not limit the scope of the invention to cover dividing walls that are not formed as a separate insert. The insert 116 may comprise fiberglass or any other suitable material, such as aluminum or concrete. Such alternative materials are well-known to those skilled in the art, and all such materials are envisaged by the inventor. The insert 116 may be formed from a water-impervious material, but it may be desirable, in some cases, to form all or part of the insert with a porous material. Furthermore, the insert 116 may be formed as a separate part that is installed into the tank 119, or as an integral part of other parts of the gross pollutant trap 100. The insert 116 may be positioned such that a portion of the tank 119 below the insert 116 forms the treatment chamber 128 and the portion of the tank 119 above the insert 116 forms the bypass chamber 126.

In one embodiment, the insert 116 includes a first end 116a and a second end 116b opposite the first end 116a. The insert 116 may be dimensioned such that the first end 116a, the second end 116b, and the rest of the insert's perimeter rest substantially adjacent or snugly against the inner walls of the tank 119, and form a generally water-tight seal around the insert 116. Sealing materials, such as gaskets or caulks may be used to enhance this seal. Providing such a seal helps ensure that the majority of the fluid passes through the insert 116 in the desired manner, as described in more detail below. Of course, it is not necessary for there to be a perfect seal between these parts, and the use of the expressions “water-tight” and the like are intended to convey an understanding that there is a relatively high resistance to allowing water to pass, but absolute water-imperviousness is not required of all embodiments.

The insert 116 includes an inlet opening 120, an outlet opening 122, and a weir 124, and may include a plurality of retaining devices, such as rods 125a, 125b. The inlet opening 120 may be an aperture formed through the insert 116. In some embodiments, the inlet opening 120 may be proximal to the inlet port 112 and adapted to enable communication from the bypass chamber 126 to treatment chamber 128.

In one embodiment, the inlet opening 120 may be positioned at any location in the insert 116 such that a substantial volume of liquid entering the inlet port 112 and/or the entry hole 110 may enter the tank 119 and fall into the inlet opening 120. For example, the inlet opening 120 may be in a region substantially vertically aligned with the entry hole 110 and/or the inlet port 112.

The illustrated inlet opening 120 includes a short tubular drop pipe 120′ that extends downward from the lower surface 116d of the insert 116, but this is not required. The inlet opening 120 may optionally be coupled to or integrally formed with an extended inlet drop pipe (not shown) that conveys fluid passing through the inlet opening 120 further down in the treatment chamber 128 than in the shown embodiment. Such an inlet drop pipe may be coupled to the inlet opening 120 by any means, such as by dropping it through the inlet opening 120 from above, as known in the art. In this embodiment, the drop pipe can be easily removed by simply lifting the drop pipe out of the opening. Accordingly, this embodiment provides an additional measure of ease of maintenance by allowing the drop pipe to be removed to assist with cleaning the gross pollutant trap 100. As known, such drop pipes may be tailored to have a specific size, shape or have any of various features such that the drop pipes, and therefore the gross pollutant trap, are tailored for specific applications that may be desired by different consumers. For example, the drop pipe may have a “T” fitting, “J” fitting, or other features that direct the fluid flow in the treatment chamber 128.

As shown, the inlet drop pipe 120′ may terminate at an elevation above the elevation of the bottom of the outlet port 114. Providing a gap in this manner may promote the creation of a gap or air space between the bottom of the drop pipe 120′ and the surface of the fluid retained in the treatment chamber 128 during zero-flow conditions (i.e., when no fluid is entering the device). When present, this gap allows floating debris to move so that it is not directly beneath the inlet drop pipe 120′.

The outlet opening 122 comprises an aperture formed through the insert 116. The outlet opening 122 provides fluid communication between the treatment chamber 128 and the bypass chamber 126, and may be proximal to the outlet port 114 to allow fluid exiting the treatment chamber 128 to pass to the outlet opening 122 and out of the tank 119 through the outlet port 114.

As shown, the outlet opening 120 may be coupled to or integrally formed with an outlet drop pipe, but this is not required. The outlet drop pipe may be removable, have a “T” or “J” fitting, or have other features, such as described above and otherwise known in the art. In some embodiments, the outlet opening 122 may include or receive a screen or filter apparatus 123 to help remove some or all solid pollutants from the liquid as it passes through the outlet opening 122. Such a screen apparatus 123 may be adapted to substantially cover the bottom, top or some intermediate portion of the outlet opening 122, and may comprise structures such as a wire mesh or a grate.

The inlet opening 120 and outlet opening 122 may be substantially circular in shape, but other shapes may be used and are envisaged by the inventor. In some embodiments, the inlet opening 120 may be dimensioned to be substantially larger than outlet opening. A range of inlet openings for typical applications might be from 24 inches to 48 inches, but other sized may be used depending on the circumstances. Similarly, the outlets openings may be about 12 inches to about 24 inches—again, variations may be made depending on the circumstances. The total area of the inlet opening or openings may be greater, the same as, or less than the total area of the outlet opening or openings.

The insert 116 may be formed such that the inlet opening 120 is disposed at a higher elevation than the outlet opening 122. For example, the exemplary insert 116 includes an inlet floor 116c located adjacent the inlet port 112 and surrounding the inlet opening 120, and an outlet floor 116d located adjacent the outlet port 114 and surrounding the outlet opening 122. The inlet floor 116c is elevated higher than the outlet floor 116d, thus positioning the inlet opening 120 higher than the outlet opening 122. Having the inlet opening 120 elevated higher than the outlet opening 122 may enable additional storage volume under the insert 116 for pollutants that float into that region. Further, it may advantageously encourage liquid to flow from the inlet port 112 to the outlet port 114 during heavy rainfall events. While the foregoing arrangement is believed to be useful, it is not required. For example the inlet floor 116c may be at the same level, or even lower than, the outlet floor 116d.

The weir 124 comprises a vertically-extending protrusion or structure having the inlet opening 120 and inlet port 112 located on one side, and the outlet opening 122 and outlet port 114 located on the other side. In those embodiments in which the entry hole 110 serves as a fluid inlet, the weir 124 is positioned with the entry hole 110 and the inlet opening 120 on one side, and the outlet opening 122 and outlet port 114 on the other side. The weir 124 extends vertically within the bypass chamber 126, but does not fully obstruct the bypass chamber. Thus, the weir 124 prevents fluid from passing from the inlet port 112 to the outlet port 114 without either passing through the treatment chamber 128, or flowing over the weir. Typically, fluid will flow through the treatment chamber 128 during low flow conditions, but as the fluid flow rate increases, it may eventually overflow the weir 124. This operation is described in more detail subsequently herein.

While the weir 124 may comprise a simple wall formed from a sheet of material, in the exemplary embodiment, the weir 124 comprises a three-dimensional protrusion formed by the insert wall. In this embodiment, the weir 124 includes an inlet wall 124a that is inclined upwards at an angle from the inlet floor 116c, a peak 124b located at the top of the inlet wall 124a, a first outlet wall 124c that drops vertically from the peak 124b, and a second outlet wall 124d that extends at an angle from the bottom of the first outlet wall 124c to the outlet floor 116d. The angles at which the inlet wall 124a and outlet walls 124c, 124d extend may be varied in various embodiments, and the outlet walls 124c, 124d may comprise a single wall. In addition, the inlet and outlet walls 124a, 124c, 124d may be vertical, curved, or have other shapes. The peak 124b is shown as being an edge, but it may be flattened, rounded, or have other shapes in other embodiments.

In some embodiments, the insert 116 may include a storage volume located under the weir 124 and/or other portions of the insert 116, in which lighter and buoyant debris may be captured. For example, the space below the weir inlet and outlet walls 124a, 124c, 124d provides some storage volume, as does the space below the inlet floor 116c. In fact, in this embodiment, the storage volume may include the entire interior portion of the insert 116 that is hollow and open to treatment chamber 128. Furthermore, where the outlet opening 122 is provided with a drop pipe, as shown, the storage volume for lighter-than water debris, such as oil and floatables, can extend all the way to the bottom of the outlet drop pipe. If necessary or desired, a vent (not shown) may be provided to allow gas to escape the storage volume.

In the embodiment if FIG. 1, the insert 116 includes one or more retaining rods 125a, 125b. Two retaining rods 125a, 125b are illustrated in this view, but more or fewer rods may be used, as will become apparent from the following disclosure. Each retaining rod 125a, 125b may be coupled to and disposed to extend from the lower surface of the insert 116, in the region surrounding the inlet opening 120. The retaining rods 125a, 125b may be mounted to the insert 116 at a fixed angle, or pivotably mounted thereto. In the shown embodiment, the retaining rods 125a, 125b are substantially parallel to the first interior side wall 110a and/or second interior side wall 110b of the tank 119, and substantially perpendicular to the insert inlet floor 116c. However, the retaining rods may be mounted at an angle, as shown by the dotted line illustrations of retaining rods 125a′ and 125b′. Such angled mounting may be helpful to direct the float 140 to the side when the fluid level in the tank 119 lowers, thereby clearing the inlet opening 120 to allow the insertion of a vacuum cleaning hose.

The retaining rods 125a, 125b hold the float 140 within a retention space located generally under the inlet opening 120. As noted above, in other embodiments, there may be any number of retaining rods. In one embodiment, there are three retaining rods that form a vertical prismatic shape in which the float 140 can move vertically. In other embodiments, other numbers of rods may be used, and the dimensional retention space may be in the form of any number of shapes, including, but not limited to, circular, square, oblong, triangular, irregular or otherwise. In still other embodiments, the retaining rod or rods may cooperate with the walls of the tank 119 or insert 116 to capture the float 140 in a retention space, or the rod or rods may pass through holes in the float 140 to capture the float 140 in place from within. Other variations will be apparent to persons of ordinary skill in the art in view of the present disclosure.

The retention rods may comprise any suitable material and construction. For example, they may comprise iron or steel rods that are embedded in, adhered to, threaded into, or bolted through the insert. The retention rods also may comprise integrally formed extensions of the insert, or portions of a cylindrical wire cage. It will be understood, however, that other structure for retaining the float within a space below the inlet opening may be used. For example, the float may be mounted on tracks, on one or more weighted chains, or on other retention devices. These and other variations be apparent to persons of ordinary skill in the art in view of the present disclosure.

The float 140 may comprise any material that may float in a selected liquid located in the treatment chamber 128. For example, the float 140 may comprise a naturally buoyant material that floats in water, waste-laden water, oil, or other typical stormwater fluids. The float 140 also may comprise a non-buoyant material that is shaped for form a buoyant chamber, such as a hollow metal or plastic sphere. The float 140 also be adapted such that its buoyancy can be adjusted, which can be used to modify the operation of the device and the flow rate at which the float will rise against the inlet opening 120. For example, the float may have a sealable opening through which ballast can be inserted, or it may have an external ballast mounting point, such as a threaded rod to receive similarly threaded weights.

Preferably, the float 140 is shaped and dimensioned such that it is captured in the dimensional retention space formed by the retaining rods 125a, 125b, and can move at least some distance towards and away from the inlet opening 120. The retaining rods 125a, 125b also may be shaped or positioned to prevent the float 140 from falling out of the retention space regardless of the level of the fluid in the treatment chamber 128. The float 140 also may be shaped such that it tends to cause floating debris to move away from the bottom of the inlet opening 120. For example, the float 140 may comprise a spherical chamber that rises partially above the surface of fluid residing in the treatment chamber 128 during zero-flow conditions, and in doing so forces floating debris to the side and away from the inlet opening 120. This may help prevent such debris from rising back into the inlet opening 120 during high flow conditions, as described below.

The float 140 may comprise a spherical structure, a cylindrical structure, or other suitable floating structures. The shape may be similar to or complementary to the shape of inlet opening 120, such that the float partially or entirely blocks inlet opening 120 when it is lifted upwards. Shaping the float 140 to block the inlet opening 120 may help preventing or inhibit debris captured in treatment chamber 128 from floating out of inlet opening 120 and into bypass chamber 126 during both normal and heavy rainfall events.

In use, the gross pollutant trap 100 may operate as follows. During normal rainfall, fluid 130, including pollutants therein, may enter the tank 119 through the inlet port 112 and/or entry hole 110. The fluid enters the bypass chamber 126 near the inlet opening 120, and, being obstructed from reaching the outlet port 114 by the weir 124, flows down into the treatment chamber 128 through the inlet opening 120. During such conditions, the float 140 floats within the space formed by the retaining rods 125a, 125b but does not seal against the inlet opening 120. The float also may provide a relatively large opening through which floatables, such as empty cans and bottles and the like, can pass to enter the treatment chamber 128. Thus, fluid and debris are generally free to pass by the float 140 to enter the treatment chamber 128. Furthermore, if an air gap is provided between the bottom of the inlet drop pipe 120′ and the fluid level in the tank 119, it may not be necessary to generate a strong vortex flow to encourage lighter objects and fluids to pass completely down through the drop pipe 120′ during such conditions.

The fluid 130 that enters the treatment chamber 128 through the inlet opening 120 passes through the treatment chamber 128, during which time lighter debris 132, such as oil, oil-based debris, and floating objects, such as empty containers, rise into the upper portion of the treatment chamber 128 adjacent the bottom of the insert 116 and under the weir 124. Meanwhile, heavier debris 134, such as sediment and waterlogged containers, settles near the bottom of the treatment chamber 128. The fluid 130 then passes through the outlet opening 122, and exits the tank 119 through the outlet port 114.

During heavy rainfall events, the volume of liquid 130 entering through the inlet port 112 increases, and eventually may reach the point where it begins to overflow the weir 124. At the same time, the increased flow causes the float 140 to rise upwards to at least partially seal against the inlet opening 120, however some fluid may continue to pass by the float 140 and continue through the treatment chamber 128 as during normal low flow conditions. The combination of the weir 124 and the float 140 may provides at least two beneficial flow-controlling effects. First, the weir 124 allows at least a portion of high flows of fluid to bypass the treatment chamber, which helps regulate the flow volume through the treatment chamber 128 and prevent the incoming rush of fluid from entraining and removing pollutants collected in the treatment chamber 128 (which is known as “scouring”). Second, the float 140 helps prevent lighter pollutants, such as oil and floatables, from rising out of the treatment chamber 128 through the inlet opening 120 during high flow events and being removed by the rush of fluid.

According to the foregoing operation, during normal rainfall and flow conditions, pollutants are captured in the treatment chamber 128, from which they can be periodically removed by maintenance workers. During high flow conditions, the gross pollutant trap 100 is designed to inhibit captured pollutants from being removed during high flow events. It will be understood that the operation of the trap 100 may be modified by altering various factors, such as the buoyancy of the float 140, the sizes of the inlet and outlet openings 120, 122, the height differential between the inlet and outlet ports 112, 114, and so on. Such modifications are within the understanding of persons of ordinary skill in the art and the most useful dimensions for these features will be readily ascertainable without undue experimentation after considering the present disclosure and studying the desired application for the device.

FIG. 2 is a perspective view of a gross pollutant trap 200 having an dividing wall similar to the insert shown in FIG. 1. The gross pollutant trap 200 includes an inlet port 210, outlet port 212, insert 218, bypass chamber 222 and treatment chamber 224. The dividing wall includes an inlet opening 214 from the bypass chamber 222 to the treatment chamber 224, an outlet opening 216 from the treatment chamber 224 to the bypass chamber 222, and a weir 220 similar to the one described above.

The inlet port 210 is configured to receive liquid (not shown) and transmit the received liquid to inlet opening 214. The outlet opening 216 is adapted to transmit the filtered liquid from treatment chamber 224 to bypass chamber 222 and out of trap 200 through outlet port 212. During normal flow conditions, the fluid all passes through the treatment chamber 224, but during high flow conditions, some or all of the water will pass over the weir 220 to travel from the inlet port 210 to the outlet port 212 without passing through the treatment chamber 224.

FIGS. 3 and 4 are perspective views, and FIG. 5 is a plan view, of an exemplary insert and float in accordance with an embodiment of the present invention. In the embodiments shown the insert 300 includes an inlet opening 310, an outlet opening 312, a weir 314 and retaining rods 318. As described with reference to FIG. 1, in various embodiments, the retaining rods 318 may be sized to create a retention space dimensioned to receive a float 316. The insert 300 may be positioned inside a gross pollutant trap 100 or any other pollutant capturing devices. As shown in FIG. 5, the inlet opening 310 may be located such that it is centered within the weir 314, but this is not required in all embodiments.

FIG. 6 is a perspective view of another exemplary gross pollutant trap 600 having an insert in accordance with an embodiment of the present invention. The gross pollutant trap 600 includes an inlet port 610, outlet port 612, insert 618, bypass chamber 622 and treatment chamber 624. The insert 618 includes an inlet opening 614, outlet openings 615, 616, 617 and a weir 620. In some embodiments, each of the outlet openings 615, 616, 617 may be located at substantially the same elevation relative to the inlet opening 614. The outlet openings 615, 616, 617 may be substantially the same diameter, or may have different diameters. In this embodiment, the insert 618 may provide an advantage in that it divides the fluid flowing from the treatment chamber 624 to the bypass chamber 622 into multiple streams. This allows each outlet opening 615, 616, 617 to be smaller, while still obtaining the desired flow rates and head pressures. This, in turn, allows the outlets openings 615, 616, 617 to be arranged in a relatively narrow space that might not be large enough to accommodate a single large-diameter circular outlet opening to match the flow rate provided by the large inlet opening 614. Thus, a first advantage of this embodiment may be that it allows the inlet opening 614 to be relatively large, which allows larger and more debris to enter the treatment chamber 624. This embodiment may also create relatively little head pressure during use, due to the enlarged inlet and outlet openings. Furthermore, this embodiment may be less likely to clog because large objects, such as trash bags and the like, may be less likely to entirely block the flow of fluid from the treatment chamber 624 to the bypass chamber 622, because such blockage would have to occur over all three outlet openings 615, 616, 617 at once to completely block the system.

Each outlet opening 615, 616, 617 may be coupled to or integrally formed with a respective outlet drop pipe below outlet openings 615, 616, 617. The outlet openings 615, 616, 617 also may have grates or other filtrations devices. The outlet openings 615, 616, 617 also may be positioned such that liquid may easily flow out from the outlet openings 615, 616, 617 to outlet port 612.

The insert 618 also may include a vent aperture 626, which may be connected to a hose or pipe (not shown) to allow gas that might accumulate under the insert 618 to vent outside the trap 600.

FIGS. 7 and 8 are perspective views, and FIG. 9 is a plan view, of the exemplary insert and float of FIGS. 10 and 11. In this embodiment, an insert 700 is provided having an inlet opening 710, a weir 714 and retaining rods 718. The insert 700 also includes a plurality of outlet openings 711, 712, 713. While three such outlet openings are shown, only two, or more than three may be provided in other embodiments. As described with reference to FIG. 1, the retaining rods 718 may be sized to create a dimensional retention space that receives a float 716, and allows the float 716 to rise to cover or partially cover the inlet opening 710, but descend to uncover the opening 710.

The insert 700 of this or other embodiments also may include a weir extension 720 that projects upwards from the weir 714. The extension 720 may comprise a solid wall, a mesh grate, or a combination of solid and fluid-pervious structures. The weir extension 720 also may be extendable. For example, the weir extension 720 may have a height of 24 or so inches, and be extendable to up to twice this height. An extendable weir may be constructed, for example, by providing two closely fit walls, one of which is attached to the weir 714, and the other which is attached to the first wall by slots or other telescoping attachment arrangements.

The weir extension 720 may be bolted or screwed to the top of the weir 714, or otherwise attached. For example, the weir extension 720 may have a generally c-shaped bracket that fits over the top part of the weir 714. Where the extension 720 is solid, it can be provided to generate additional head pressure over the inlet opening 710 to allow the insert 700 to operate at higher flow rates. Where the extension 720 is a water permeable grate or other structure, it may be used to prevent large debris from being conveyed over the weir and potentially blocking the outlet port of the pollutant trap in which the insert 700 is installed. A permeable extension 720 may extend partially or entirely to the top of the tank in which the device is mounted. The extension 720 also may stop short of the top of the tank, and include a lip or a horizontal extension to help capture debris. Where the permeable extension 720 extends to the top of the tank, an emergency bypass, such as a pressure-sensitive door on the extension 720 may be provided to ensure that flow is not completely blocked if the extension 720 becomes covered by debris. Other uses for such devices will be apparent to persons of ordinary skill in the art in view of the present disclosure.

As best shown in FIG. 9, the insert may have its inlet opening 710 located off-center with respect to the weir 714. For example, the weir 714 may include an asymmetrical portion that forms an enlarged inlet floor area 722 on one side of the inlet opening 710. The use of this off-center inlet opening 710 may encourage the creation of a vortex or vortices to help convey fluid through the inlet opening 710. This effect may be enhanced if the inlet port provides fluid into the enlarged portion of the floor area 722 or at an angle into the area behind the weir. To this end, the inlet opening and/or inlet floor area 722 may be funnel-shaped, such as shown in FIGS. 10 and 11, to help encourage the creation of a large vortex around the inlet opening 710. The wall of this funnel-shaped inlet may be conical, as shown, curved, or have other shapes or combinations of shapes.

The inlet opening 710 and outlet openings 711, 712, 713 may have any suitable shape and size. For example, in an exemplary embodiment in which the insert 700 has a diameter of about 119.5 inches, the inlet may be circular, and have a diameter of about 42 inches. Also in this exemplary embodiment, the inlet is attached to a drop pipe (see FIG. 10) having a length of about 13 inches (including the funnel-shaped floor). The, three outlet openings 711, 712, 713 each may have a diameter of about 24.5 inches. In this embodiment, the total area of the inlet opening 710 is about 1,385 square inches, and the total area of the outlet openings is about 1,414 square inches, which provides relatively little restriction at the outlet openings, as compared to the inlet opening. In other embodiments, the inlet and outlet openings may be sized differently, and such sizing will be within the understanding of persons of ordinary skill in the art in view of the present disclosure. It will be understood that the relationship of the outlets and inlets may be reversed, that is, with multiple inlets and a single outlet, or with multiple inlets and outlets.

FIGS. 10 and 11 are cross-sectional views of the pollutant trap insert of FIGS. 7-9. FIG. 10 illustrates the insert 700 as seen along view 10-10 in FIG. 9, and FIG. 11 is taken along view 11-11 in FIG. 9. Some features are omitted for clarity in FIGS. 10 and 11. As shown in these Figures, the retaining rods 718 may be curved to form a retention space in which the float 716 rises to abut the inlet 710 when the fluid level is high, but lowers to clear the inlet opening 710 when the fluid level is low. This allows improved access into the treatment compartment when the water level is low. Also shown in FIGS. 10 and 11 are optional drop pipes 1001 provided on each outlet opening 711, 712, 713. Alternatively, the drop pipes 1001 may be omitted, or varied from one outlet opening to the next. Any suitable drop pipe may be used. Filters (not shown), such as a stainless steel mesh having 4 mm or smaller openings, may be attached to the drop pipes 1001. Of course, the size of the mesh also may be greater than 4 mm.

Finally, FIGS. 10 and 11 illustrate the inlet opening 710 having a conical wall 710′, and the inlet floor 722 having a dish-like shape. Either or both of these features may be provided in alternative embodiments to help encourage vortex formation.

It should be understood that the foregoing embodiments described in the specification and drawings are exemplary only, and other embodiments will be apparent to those of ordinary skill in the art in light of the teachings provided herein and with practice of the invention. For example, in various alternative embodiments, the float may be captured on a track, pivotally coupled or otherwise retained, shaped or positioned such that it can open and close an inlet opening or inlet drop pipe through an insert. Furthermore, a float may be located remote from the inlet opening or inlet drop pipe, and operatively coupled to a closure member, such as a door, such that the float opens and closes the closure member as it rises and falls in the containment chamber. In still other embodiments, the float may be omitted. For example, the invention provides an insert or dividing wall structure having a unique arrangement of inlet(s) and outlet(s) that allow the structure to fit in compact spaces as compared to the cross-sectional area of the inlet(s) and outlet(s). In addition, while the disclosure typically refers to using the inserts described in as or within gross pollutant traps, other uses will be apparent, and it is not required for the invention to be used to collect any particular kind or size of pollution. All such variations and embodiments are within the scope of the invention as envisaged by the inventors.

What is claimed is:

1. A system for removing pollutants from a polluted liquid, the system comprising:
a tank having a bypass chamber, a treatment chamber, an inlet port and an outlet port;
a dividing wall located within the tank and thereby defining the bypass chamber and the treatment chamber, the dividing wall having an inlet opening, one or more outlet openings, a plurality of retaining rods forming a retention space located at least partially below the inlet opening, and a vertically-extending weir located between the inlet opening and the one or more outlet openings, wherein the inlet opening is positioned to receive the polluted liquid from the inlet port and the one or more outlet openings are positioned to output a cleaned liquid to the outlet port; and
a float is provided in the treatment chamber and adapted to float in a retention space formed by the plurality of retaining rods, the float being adapted to rise against the inlet opening when a fluid level in the treatment chamber reaches a predetermined level to substantially block the inlet opening.

2. The system of claim 1, wherein the dividing wall includes two or more outlet openings.

3. The system of claim 1, wherein the inlet opening is located at a first elevation and the outlet opening is located at a second elevation, the first elevation being higher than the second elevation relative to a vertical dimension of the tank.

4. The system of claim 1, wherein the dividing wall comprises a removable insert.

5. The system of claim 1, wherein at least a portion of the weir has a frustoconical shape.

6. The system of claim 1, wherein the weir comprises an asymmetrical shape, and the inlet opening is located proximal to one side of the weir.

7. The system of claim 1, wherein the weir is adapted to direct liquid received from the inlet port through the inlet opening and cause the liquid to form a vortex as it passes through the inlet opening.

8. The system of claim 1, further comprising an adjustable weir extension attached to and extending upwards from the weir.

9. The system of claim 1, wherein one or more of the plurality of retaining rods extends generally vertically downward from the dividing wall.

10. The system of claim 1, wherein one or more of the plurality of retaining rods extends downward from the dividing wall at an angle with respect to a vertical dimension of the tank.

11. The system of claim 1, wherein one or more of the plurality of retaining rods is curved, such that the float is adjacent the inlet opening when the fluid level in the treatment chamber reaches a predetermined level, and descends to a located substantially laterally offset from the inlet opening when the fluid level in the treatment chamber drops to a second predetermined level.

12. The system of claim 1, wherein the float is spherical.

13. The system of claim 1, wherein the float comprises a buoyant material.

14. The system of claim 1, wherein the float comprises a buoyant chamber.

15. An insert for removing pollutants from a polluted liquid, the insert comprising a housing having a first aperture adapted to receive the polluted liquid, a second aperture adapted to output cleaned liquid, a weir positioned between the first aperture and the second aperture, and plurality of retaining rods extending below a bottom surface of the insert.

16. The insert of claim 15, further comprising a third aperture and a fourth aperture, each of the third aperture and the fourth aperture adapted to output cleaned liquid.

17. The insert of claim 15, wherein one or more of the plurality of retaining rods extends generally perpendicular to the insert.

18. The system of claim 15, wherein one or more of the plurality of retaining rods extends generally at an angle with respect to the insert.

19. The system of claim 1, wherein the plurality of retaining rods creates a generally curved retentions space in which a float is provided.

20. An insert for removing pollutants from a polluted liquid, the insert comprising:
an inlet opening and a plurality of outlet openings formed through the insert, wherein the inlet opening is positioned at a first elevation and each of the plurality of outlet openings is positioned at a second elevation, the first elevation being greater than the second elevation;
a weir having an elevated weir portion that is located between the inlet opening and the plurality of the outlet openings and is non-symmetrical relative to an edge of the inlet opening; and
one or more retention devices positioned below the bottom surface of the insert and forming a dimensional space adapted to receive a mechanism dimensioned to reside in the dimensional space and substantially block the inlet opening upon detecting a predetermined level of fluid below the insert.
